(19) United States
(12) Patent Application Publication
(10) Pub. No.: US 2006/0024493 A1
(43) Pub. Date: Feb. 2, 2006

(54) Color effect/soft feel coating

(76) Inventors: R. Preston Jones, Mars, PA (US); Calum H. Munro, Wexford, PA (US); Mark D. Merritt, Cranberry Twp, PA (US)

Correspondence Address: PPG INDUSTRIES, INC.;Intellectual Property Department, One PPG Place, Pittsburgh, PA, 15272, US

(21) Appl. No.: 10/900,619

(22) Filed: Jul. 28, 2004

(51) Int. Cl. B32B 5/16; B32B 27/08; B32B 27/38; B32B 27/36; B32B 19/00

(52) U.S. Cl. 428/327; 428/520; 428/413; 428/480; 428/702

(57) ABSTRACT

Substrates with one or more coatings having both color effect and tactile effect are disclosed. The color effect composition and tactile effect composition can be included in the same coating or in different coatings.

### FIELD OF THE INVENTION

The present invention relates to substrates having one or more coating layers comprising a color effect composition and a tactile effect composition.

### BACKGROUND INFORMATION

Coatings having “special effects” are often used to impart visual effects, tactile effects, effects that prevent or deter tampering, duplication, counterfeiting and the like. For example, it is often desirable to coat hard substrates with a coating that imparts a “soft feel” to the substrates. It is desired that such “soft feel” coatings have the mechanical and chemical resistance of other coatings. It is also desired to impart various color effects to coatings including, flip-flop effects, goniochromatic effects and the like. Goniochromaticity is the effect of perceived color varying as the angle of illumination or observation varies. This is of particular interest for security and anti-counterfeiting.

While it is often desirable to combine various “special effects” in coatings, use of one special effect composition may interfere with or mask the effects of another special effect composition. Accordingly, there is a need in the art for coatings and methods that allow for the combination of special effect compositions.

### SUMMARY OF THE INVENTION

The present invention is directed to a substrate coated with one or more coating layers. At least one of the coating layers comprises a color effect composition and at least one of the coating layers comprises a tactile effect composition. The color effect and tactile effect compositions can be in the same layer or in different layers.

The present invention provides coatings having both a color effect and a tactile effect. Significantly, the use of one does not impede or interfere with the effect of the other. This is an advantage over other coatings in the art where, for example, the application of a tactile effect composition over a composition having a color effect impedes the color effect.

### BRIEF DESCRIPTION OF THE FIGURES

FIG. 1 is a cross-section of a color effect composition made in accordance with one embodiment of the present invention.

### DETAILED DESCRIPTION OF THE INVENTION

The present invention is directed to a substrate coated with one or more coating layers, wherein at least one coating layer comprises a color effect composition and at least one coating layer comprises a tactile effect composition, wherein both the color effect and the tactile effect are present. A “color effect composition” refers to any composition that imparts a desired color effect to a coating. Examples include compositions that comprise transparent coated micas and/or synthetic micas, coated silica, coated alumina, transparent liquid crystal pigments, liquid crystal coatings, and/or any composition wherein interference results from a refractive index differential within the material and not because of the refractive index differential between the surface of the material and the air. In one embodiment, the color effect composition comprises an ordered periodic array of particles held in a matrix. In another embodiment, the particles in the array comprise a radiation diffractive material. A “tactile effect composition” refers to a composition that, when applied to a substrate, produces a desired feel. For example, the tactile effect can be to impart a soft texture or “soft feel” to the substrate.

In one embodiment of the present invention, the color effect composition includes an ordered periodic array of particles held in a matrix wherein the difference in refractive index between the matrix and the particles is at least about 0.01, such as at least about 0.05, or at least about 0.1. The matrix may be an organic polymer, such as a polyurethane, polycarbonate, polystyrene, acrylic, alkyd, polyester, siloxane, polysulfide, epoxy or mixtures thereof and, in one embodiment, is crosslinked. Alternatively, the matrix may be an inorganic polymer, such as a metal oxide (e.g. alumina, silica or titanium dioxide) or a semiconductor (e.g. cadmium selenide).

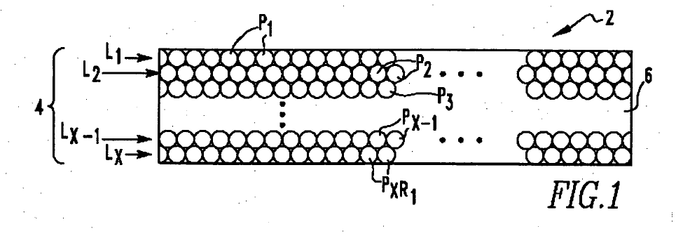

As shown in FIG. 1, the color effect composition 2 of one embodiment of the present invention includes an array 4 of particles P₁, P₂, . . . Pₓ₋₁, and Pₓ held in a polymeric matrix 6. The volumetric ratio of particles to matrix can range from 25:75 to 80:20, such as 72:28 to 76:24. The particles typically have an average particle size of about 0.01 to about 1 micron, such as 0.06 to 0.5 micron; the particles will typically be similar in size and in one embodiment differ in size from each other by a maximum of 5 to 15 percent. The particles are arranged in layers L₁, L₂, . . . Lₓ₋₁, and Lₓ stacked upon each other so that the surfaces of the particles P₁-Pₓ contact each other. The surface of each particle contacts at least one other particle. The particles P₁-Pₓ may be composed of an organic polymer, such as a polyurethane, polycarbonate, polystyrene, an acrylic polymer, an alkyd polymer, polyester, siloxane polymer, polysulfide, an epoxy-containing polymer or a polymer derived from an epoxy-containing polymer. In one embodiment, the polymer is crosslinked. Alternatively, the particles P₁-Pₓ may be composed of an inorganic polymer or material, such as a metal oxide (e.g. alumina, silica or titanium dioxide) or a semiconductor (e.g. cadmium selenide). In one embodiment, the particles and the matrix can comprise the same material, provided there is a refractive index differential.

The particles are fixed in the matrix by providing a dispersion of the particles, all bearing a similar charge, in a carrier, applying the dispersion onto a substrate such as a temporary substrate, evaporating the carrier to produce an ordered periodic array of the particles on the substrate, coating the array of particles with the matrix, and curing the matrix to fix the array of particles within the polymer. The dispersion may contain about 1 to about 70 vol. % of the charged particles, such as about 30 to about 65 vol. % of the charged particles. The substrate may be a flexible material (such as a polyester film) or an inflexible material (such as glass). The dispersion can be applied to the substrate by dipping, spraying, brushing, roll coating, curtain coating, flow coating or die coating to a desired thickness, such as a thickness of about 20 microns, about 10 microns, or about 5 microns. The fixed array of particles can be removed from the substrate in the form of an extended film or continuous layer, or removed from the substrate and converted into particles or flakes. When in the form of an extended film or continuous layer, the layer itself can be the coating comprising the color effect composition. The thickness of the film or layer can vary depending on the needs of the user. For example, the film or layer can be about 100 microns or less, such as 20 microns or less or 10 microns or less. When in particulate or flake form, the particles or flakes can be added to a coating composition. In this embodiment, the particles/flakes can comprise 0.1 to 40 weight percent, such as 1 to 20 or 5 to 15 weight percent of the total coating composition. The size of the particles/flakes can range from 5 to 5000 microns in diameter, such as 5 to 100 or 10 to 50. The color effect composition of this embodiment is further described in U.S. Publication No. 2003/0125416, incorporated by reference herein.

At least one coating layer according to the present invention will include a tactile effect composition. Any tactile effect composition can be used.

In one embodiment of the present invention, the tactile effect composition and the color effect composition are in the same layer. For example, the color effect composition can be flaked or particularized and added to a coating having a tactile effect composition.

In another embodiment of the present invention, the color effect composition is in one coating layer, and the tactile effect composition is in another coating layer. For example, the coating that includes the color effect composition can be a basecoat, over which is applied a clearcoat that does not contain the color effect composition; the clearcoat can comprise the tactile effect composition. A soft feel clearcoat is commercially available from PPG Industries, Inc., as VELVECRON. In this embodiment, the dry film thickness of the coating comprising the color effect composition can range from 1 to 50 microns, such as 3 to 15 microns, and the dry film thickness of the coating comprising the tactile effect composition can range from 0.1 to 20 mils, such as 1.5 to 4 mils.

The color effect compositions and the tactile effect compositions used according to the present invention can be used in a wide variety of coating compositions. These include waterborne and solvent-borne liquid coating compositions, powder coating compositions, powder slurry compositions, and electrodeposition compositions. They can be used in clear coatings (i.e., those that produce cured films having substantial transparency) or they can be added to other pigments and/or dyes in colored coatings. Functionally, the coatings that may include the color effect and tactile effect compositions according to the present invention include primers, basecoats, and topcoats, as well as any one or more of the coatings in a multi-coat combination. Compatibility of the color effect and tactile effect compositions with a variety of polymer types has been observed, and it can be expected that any known film-forming polymer composition used for coatings could be used. Some of the more common families of polymer compositions used in coatings include polyurethanes, acrylic polymers, alkyd polymers, polyesters, siloxane-containing polymers, polysulfides, epoxy-containing polymers, and polymers derived from epoxy-containing polymers and combinations thereof. These are known to be provided in coatings as lacquers, thermoplastics, or thermosetting types of compositions. Thermosetting compositions will further include cross-linking agents, such as polyisocyanates, amino-formaldehyde aminoplasts, polyacids, polyanhydrides, and combinations thereof. As used herein, “film-forming” means that the materials form a self-supporting continuous film on at least a horizontal surface upon removal of any solvents or carriers present in the composition or upon curing at ambient or elevated temperature.

Volatile materials that can be included as diluents in the liquid or powder slurry coating compositions include water and/or organic solvents, such as alcohols, ethers and ether alcohols, ketones, esters, aliphatic and alicyclic hydrocarbons, and aromatic hydrocarbons as are commonly employed in the coating industry. Examples of solvents for coatings include aliphatic solvents, such as hexane, naphtha, and mineral spirits; aromatic and/or alkylated aromatic solvents, such as toluene, xylene, and SOLVESSO 100 (aromatic blend from Exxon Chemicals); alcohols, such as ethyl, methyl, n-propyl, isopropyl, n-butyl, isobutyl and amyl alcohol, and m-pryol; esters, such as ethyl acetate, n-butyl acetate, isobutyl acetate and isobutyl isobutyrate; ketones, such as acetone, methyl ethyl ketone, methyl isobutyl ketone, diisobutyl ketone, methyl n-amyl ketone, and isophorone, glycol ethers and glycol ether esters, such as ethylene glycol monobutyl ether, diethylene glycol monobutyl ether, ethylene glycol monohexyl ether, propylene glycol monomethyl ether, propylene glycol monopropyl ether, ethylene glycol monobutyl ether acetate, propylene glycol monomethyl ether acetate, and dipropylene glycol monomethyl ether acetate.

The coating compositions can further include one or more additives, such as UV absorbers and stabilizers, rheology control agents, surfactants, catalysts, film build additives, fillers, flatting agents, defoamers, microgels, pH control additives, and other pigments. Along with the color effect compositions, it may be useful in some cases to also include conventional pigments and dyes. These include micas, iron oxides, carbon black, titanium dioxide, aluminum flakes, bronze flakes, coated mica, nickel flakes, tin flakes, silver flakes, copper flakes, and combinations thereof. Other organic coloring agents (e.g., dyes or organic pigments) could also be included.

The coating layer(s) of the present invention can be applied to the substrate using any suitable means, such as die coating, direct roll coating or reverse roll coating, curtain coating, spray coating, brush coating, gravure coating, flow coating, slot-dye coating, ink-jet coating, electrodeposition, and any combinations thereof. Powder coatings are generally applied by electrostatic deposition. One skilled in the art can select proper application methods if more than one layer is used, and will further know how to affect cure of the coating layer(s).

Any substrate can be coated according to the present invention. Particularly suitable are those substrates having decorative printing.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

### Ultraviolet Radiation Curable Organic Composition

An ultraviolet radiation curable organic composition was prepared via the following procedure. Diphenyl (2,4,6-trimethylbenzoyl) phosphine oxide/2-hydroxy-2-methylpropiophenone (30 grams), 50/50 blend from Aldrich Chemical Company, Inc., Milwaukee, Wis., in 818 g of ethyl alcohol, 140 grams of SR 295 from Sartomer Company, Inc., Exton, Pa., and 130 grams of SR494 from Sartomer Company, Inc., Exton, Pa., were added with stirring to 730 grams SR9020 from Sartomer Company, Inc., Exton, Pa.

### Example 2

### Dispersion of Polymer Particles in Water

A dispersion of polymer particles in water was prepared via the following procedure: 2.45 grams of sodium bicarbonate from Aldrich Chemical Company, Inc., was mixed with 2045 grams of deionized water and added to a 1 gallon reaction kettle equipped with a thermocouple, baffles, stirrer, reflux condenser, heating mantle, and nitrogen inlet. The mixture was sparged with nitrogen for 40 minutes with stirring and blanketed with nitrogen. Aerosol MA80-I (26.5 grams) from Cytec Industries, Inc., West Paterson, N.J., in 229 grams deionized water was added to the mixture with stirring, and the mixture was heated to 50° C. using an electric mantle. Styrene monomer (416.4 grams) from Aldrich Chemical Company, Inc., was added with stirring. The mixture was heated to 60° C. Sodium persulfate from Aldrich Chemical Company, Inc., (6.2 g in 72 grams of deionized water) was added to the mixture with stirring. Divinyl benzene (102.7 grams), from Aldrich Chemical Company, Inc., was added to the mixture with stirring. Styrene monomer (100.0 grams), methyl methacrylate monomer (239.4 grams), ethylene glycol dimethacrylate monomer (24.0 grams) and divinyl benzene monomer (15.1 grams) from Aldrich Chemical Company, Inc., were added with stirring. 3-Allyloxy-2-hydroxy-1-propanesulfonic acid, sodium salt (41.4 grams, 40% in water) from Aldrich Chemical Company, Inc. was added to the mixture with stirring. The temperature of the mixture was maintained at approximately 60° C. for 6 hours. The resultant polymer dispersion was allowed to cool to room temperature and was filtered through a 325 mesh stainless steel screen. The process was repeated. The two resultant dispersions were added together and ultrafiltered using an EP2524-BS01-T2 column from PTI Advance Filtration, Oxnard, Calif. Deionized water (approximately 600 grams) was added to the dispersion after approximately 600 grams of ultrafiltrate had been removed. This exchange was repeated 15 times. Additional ultrafiltrate was then removed until the solids content of the mixture was 41.2 percent by weight.

### Example 3

### Color Effect Film

Eighteen hundred grams of material prepared in Example 2 was applied via slot-die coater from Frontier Technologies, Towanda, Pa. to a polyethylene terephthalate substrate and dried at 180° F. for 40 seconds to a porous dry film thickness of approximately 7.0 microns. One thousand grams of material prepared in Example 1 was applied via slot-die coater from Frontier Industrial Technologies into the interstitial spaces of the porous dry film on the polyethylene terephthalate substrate, dried at 150° F. for 40 seconds, and then ultraviolet radiation cured using a 100 W mercury lamp.

### Example 4

### Color Effect Packaging

Fourteen hundred grams of a radiation curable composition comprising 1190 grams of SR-9020 from Sartomer Company, Inc., Exton, Pa., and 24 grams of Diphenyl (2,4,6-trimethylbenzoyl) phosphine oxide/2-hydroxy-2-methylpropiophenone (30 grams), 50/50 blend from Aldrich Chemical Company, Inc., Milwaukee, Wis., in 210 g of ethyl alcohol, was applied via slot-die coater from Frontier Industrial Technologies, Towanda, Pa. to 1000 square feet of color effect film of Example 3. The coated film was dried at 150° F. for 40 seconds, laminated to a printed polyethylene terephthalate sheet with black, green, purple, yellow and white printing and a transparent (unprinted) window, between the two coater nip rolls under light compression (10 psi), and then ultraviolet radiation cured using a 100 W mercury lamp. The polyethylene terephthalate substrate of Example 3 was then pealed from the laminated, printed sheet while the color effect component remained attached to the laminated printed sheet. The resultant color effect laminated printed sheet was folded and glued to produce a lustrous, decorative color effect package. The perceived color of the said package changed with viewing angle to include green, blue and violet. Additionally, the transparent window displayed a lustrous blue color that changed to violet with changing viewing angle, yet remained clear and transparent.

### Example 5

### Tactile Color Effect Packaging

Example 4 was repeated except that prior to folding and gluing, the resultant color effect laminated printed sheet was further coated with 50 to 75 microns (dry film thickness) of VELVECRON XPC30002 from PPG Industries, Inc., Pittsburgh, Pa., via spray application. The painted sheet was dried at room temperature for 10 minutes then cured using a convection oven for 30 minutes at a temperature of 180° F. The resultant VELVECRON coated color effect laminated printed sheet was folded and glued to produce a lustrous, decorative color effect package. The perceived color of the said package changed with viewing angle to include green, blue and violet. Additionally, the transparent window displayed a lustrous blue color that changed to violet with changing viewing angle, yet remained clear and transparent. Further, the lustrous, decorative color effect package had a desirable tactile quality specifically having a soft velvet like feel.

### Example 6

### Comparative Example

A packaging sleeve from PINNACLE POWER CORE golf balls from Acushnet Company, Fairhaven, Mass., having an embossed hologram that exhibits a desirable color effect in that the perceived color of the package changed with viewing angle to include green, blue and violet, was unfolded and was further coated with 50 to 75 microns (dry film thickness) of VELVECRON XPC30002 via spray application. The painted unfolded package was dried at room temperature for 10 minutes then cured using a convection oven for 30 minutes at a temperature of 180° F. The resultant VELVECRON coated package was folded and glued to produce a decorative package. The decorative package had a desirable tactile quality specifically having a soft velvet like feel. However, the desirable color effect of perceived color change with viewing angle was no longer observed. This demonstrates one advantage of the present invention, in that both the color effect and soft feel are achieved.

### Example 7

### Color Effect Flake

Eighteen hundred grams of material prepared in Example 2 was applied via slot-die coater from Frontier Technologies, Towanda, Pa., to a polyethylene terephthalate substrate and dried at 180° F. for 40 seconds to a porous dry film thickness of approximately 3.5 microns. One thousand grams of material prepared in Example 1 was applied via slot-die coater from Frontier Industrial Technologies into the interstitial spaces of the porous dry film on the polyethylene terephthalate substrate, dried at 150° F. for 40 seconds, and then ultraviolet radiation cured using a 100 W mercury lamp. The cured film was removed from the polyethylene terephthalate substrate and milled to approximately 50 microns in size using a model ZM100 centrifugal mill from Retsch GmbH & Co. KG, Haan, Germany.

### Example 8

### Tactile Color Effect Coating

Twenty grams of material prepared in Example 7 was added with stirring to 80 grams of VELVECRON XPC30002. A black plastic three-dimensional style form was coated, via spray application, with the resultant coating composition to a dry film thickness of 50 to 75 microns. The perceived color of the said coated article changed with viewing angle to include blue, violet and black. Further, the lustrous, decorative color effect coating had a desirable tactile quality specifically having a soft velvet like feel.

Whereas particular embodiments of this invention have been described above for purposes of illustration, it will be evident to those skilled in the art that numerous variations of the details of the present invention may be made without departing from the invention as defined in the appended claims.

What is claimed is:

1. A substrate coated with one or more coating layers, wherein at least one coating layer comprises a color effect composition, and at least one coating layer comprises a tactile effect composition, wherein both the color effect and the tactile effect are present.

2. The substrate of claim 1, wherein the color effect composition and the tactile effect composition are in the same coating layer.

3. The substrate of claim 1, wherein the color effect composition and the tactile effect composition are in different coating layers.

4. The substrate of claim 1, wherein the color effect composition comprises an ordered periodic array of particles held in a matrix.

5. The substrate of claim 4, wherein the matrix is a polymer matrix.

6. The substrate of claim 5, wherein the polymer is a crosslinked polymer.

7. The substrate of claim 5, wherein the polymer is selected from the group consisting of a polyurethane, an acrylic polymer, an alkyd polymer, a polyester, a siloxane-containing polymer, a polysulfide, an epoxy-containing polymer, and/or a polymer derived from an epoxy-containing polymer.

8. The substrate of claim 7, wherein the polymer is a crosslinked acrylic polymer.

9. The substrate of claim 4, wherein the matrix is selected from the group consisting of a metal oxide and a semi-conductor.

10. The substrate of claim 4, wherein the particles comprise a polymeric material selected from the group consisting of a polyurethane, an acrylic polymer, an alkyd polymer, a polyester, a siloxane-containing polymer, a polysulfide, an epoxy-containing polymer, and a polymer derived from an epoxy-containing polymer.

11. The substrate of claim 10, wherein the particles comprise a crosslinked acrylic polymer.

12. The substrate of claim 4, wherein the particles comprise a material selected from the group consisting of a metal oxide and a semi-conductor.

13. The substrate of claim 4, wherein the particles have an average particle size of 0.01 to 1 microns.

14. The composition of claim 4, wherein the difference in refractive index between the particles and the matrix is greater than 0.1.
